(19) United States
(12) Patent Application Publication
(10) Pub. No.: US 2006/0087093 A1
(43) Pub. Date: Apr. 27, 2006

(54) Skateboard, backpack & gear rack

(76) Inventors: Roger Joseph Silva, Fontana, CA (US); Francine Vera Silva, Fontana, CA (US)

Correspondence Address: Curtis L. Harrington;Suite 250, 6300 State University Drive, Long Beach, CA, 90815, US

(21) Appl. No.: 11/250,564

(22) Filed: Oct. 13, 2005

Related U.S. Application Data
(63) Continuation-in-part of application No. 10/971,887, filed on Oct. 22, 2004, now abandoned.

(51) Int. Cl. B62M 1/00

(52) U.S. Cl. 280/87.042

(57) ABSTRACT

A skateboard support provides an expandable motif which gives the ability to support one, or a number of skateboards in a handy, easily accessible, and scalable structure which can support one or more skateboards. A cross pattern of support on a four-member support enables subsequent four-member supports to be located at different levels with no visual interference and only a tapering half board semi-overlap. This motif is amenable to multiplicative expansion to enable stacking with each subsequent element being located about one half of a skateboard length above its next most adjacent element. Support structures may include tubes, rings and plates from which the fork brackets may be supported. A second embodiment includes a one piece upper rack, cylindrical pole and base which can be easily deployed and stowed with simply two joinder steps.

This is a continuation-in-part of co-pending U.S. patent application Ser. No. 10/971,887 filed Oct. 22, 2004.

### FIELD OF THE INVENTION

The present invention relates to improvements in the technology relating to skateboard support, storage and display devices, and more particularly to a stable, lightweight stand which securely supports skateboards and displays them at an easily seen perspective.

### BACKGROUND OF THE INVENTION

Skateboards are notoriously difficult to store and display. They cannot be stacked without rolling off of each other, and they do not store well balanced on their end. In the home, household members, especially the very young, tend to place the skateboard near the front door. Skateboards left outside will likely be stolen, while boards left inside the door in a rolling position on the floor present a safety hazard. Without any special structures present, skateboards are likely to be left about in a random pattern on the floor.

Heavy, expensive structures can be used, much like a mailbox array having a number of openings of a height, width and depth necessary to accommodate the height, width and depth of the highest, widest and longest skateboard. Where only two or three skateboards are to be stored, such a heavy, expensive structure takes up significant space. However, such a structure would not be easily portable and could not be used to move the supported skateboards. In terms of a retail display, such a multi-compartment structure would not facilitate visual display or handling, but would hide the individual skateboards.

Another problem is cost and scalability. Dedicated supports which grasped the board surface would not adjust to thicker and thinner boards. Scaling up from a support which supports one or two skateboards to a support which holds multiple boards is not practical. If the support is an enclosure of sufficient size to hold a wide variety of sizes and types, a scale-up for holding multiple boards would multiply upward based upon the largest size board accommodated. Cost is another factor which is particularly adversely affected during scale-up. A device for displaying four boards would increase as the square in displaying 16 boards.

### SUMMARY OF THE INVENTION

A skateboard support provides the ability to support one, or a number of skateboards in a handy, easily accessible, and scalable structure which can range from a support for a single skateboard to multiple skateboards. Each support element supports a skateboard from its axle area. The geometry of placement of each support element enables two effects. First, engagement of the skateboard at its axle causes the end opposite the end being supported to tilt inward, typically placing the non-supported end inward of the point of support. Secondly, the cross pattern of support on a four-member support enables subsequent four-member supports to be located at a level about half way down with respect to the boards supported with no visual interference and only a tapering half board semi-overlap.

As a result, the rack is vertically multiplicable to enable stacking with each subsequent element being located about one half of a skateboard length above its next most adjacent element. The element configuration shown is a star “cross” pattern, but the elements can also be supported from a ring structure. In the event a ring structure is selected, the rack can have four, five, six or more individual supports at each level. As a result, the overall size of the rack in terms of diameter is expandable, maintaining the same inwardly tilting motif. The inward tilting also helps to stabilize the non-supported end of each board.

In terms of scalability, the basic element of the rack includes a fork bracket which includes pair of forks angled upwardly at an angle of about 45°. The fork bracket includes individual spaced apart forks that are each approximately 0.5 inches wide and separated from each other by a distance of about two and a quarter inches. The forks fit underneath the skateboard axle ends as they extend from a central support, with the forks fitting inboard of the wheels and outboard of the central support of a skateboard.

From a single fork bracket, the single fork brackets can be supported individually from a support wall, for example. A single fork bracket can be supported by a tube or other extension. A pair of oppositely oriented fork brackets can be supported from a single tube. A second oppositely oriented pair of fork brackets can be provided at right angles to the first, and both can be provided in a stand about three to four feet high. A further set of four fork brackets can be provided in parallel to the first set of four fork brackets set at a height of about two feet and turned about 45°. This pattern may be repeated up to a practicable height.

In terms of materials, the preferred rack can be furnished with a material strength which is needed as depends upon the total number of skateboards expected to be supported. A preferred home support is made of plastic tubing for ease of assembly and disassembly. Taller and circumferentially larger overall supports may be made of steel as is necessary to provide overall, safe support. A further benefit of lightweight plastic tubing is the ability to lift and transfer the location of the assembly with supported skateboards. A second embodiment includes a one piece upper rack, cylindrical pole and base which can be easily deployed and stowed with simply two joinder steps.

### BRIEF DESCRIPTION OF THE DRAWINGS

The invention, its configuration, construction, and operation will be best further described in the following detailed description, taken in conjunction with the accompanying drawings in which:

FIG. 1 is a side view of a tubular embodiment of a single fork bracket configured to be supported with respect to a tube;

FIG. 2 is a top view of the bracket seen in FIG. 1 and illustrating the forks and their separation;

FIG. 3 is an alternative embodiment of the fork bracket seen in FIGS. 1 and 2 in which the tubular rear portion has been replaced by a solid fin shape;

FIG. 4 is a perspective view of a one level stand having an “H” shaped base portion, vertical support and a cross shaped four member fork bracket assembly;

FIG. 5 is a plan view of the “H” shaped base portion, vertical support and a cross shaped four member fork bracket assembly of one level stand shown in disassembled view and supported by a flat surface;

FIG. 6 is a side sectional view through a section of pipe and a five way connector of the cross shaped four member fork bracket assembly and illustrating the use of a double pin thumb release utilized to achieve a more complete breakdown of components;

FIG. 7 illustrates a two level stand having two pairs of cross shaped four member fork bracket assembly for supporting two tiers of skateboards

FIG. 8 is a plan view of a three piece embodiment including a base, vertical pole and top rack having four forked brackets;

FIG. 9 is a top view looking down onto the three piece embodiment of FIG. 8 and illustrating the support of a skateboard lying across the top as an alternative to hanging the skateboard on the forked bracket;

FIG. 10 is a bottom view of the top rack having four forked brackets shown in FIGS. 8-9;

FIG. 11 is a view taken along line 11-11 of FIG. 10 and illustrating the rounded nature of the forked bracket;

FIG. 12 is a view looking down onto the base seen in FIG. 8-9;

FIG. 13 is a side view of the base shown in FIG. 12;

FIG. 14 is a sectional view taken along line 14-14 of FIG. 12;

FIG. 15 is a sectional view taken along line 15-15 of FIG. 12; and

FIG. 16 is a sectional view taken along line 16-16 of FIG. 12 and illustrating a support for an optional non-skid foot pad.

### DETAILED DESCRIPTION OF THE PREFERRED EMBODIMENT

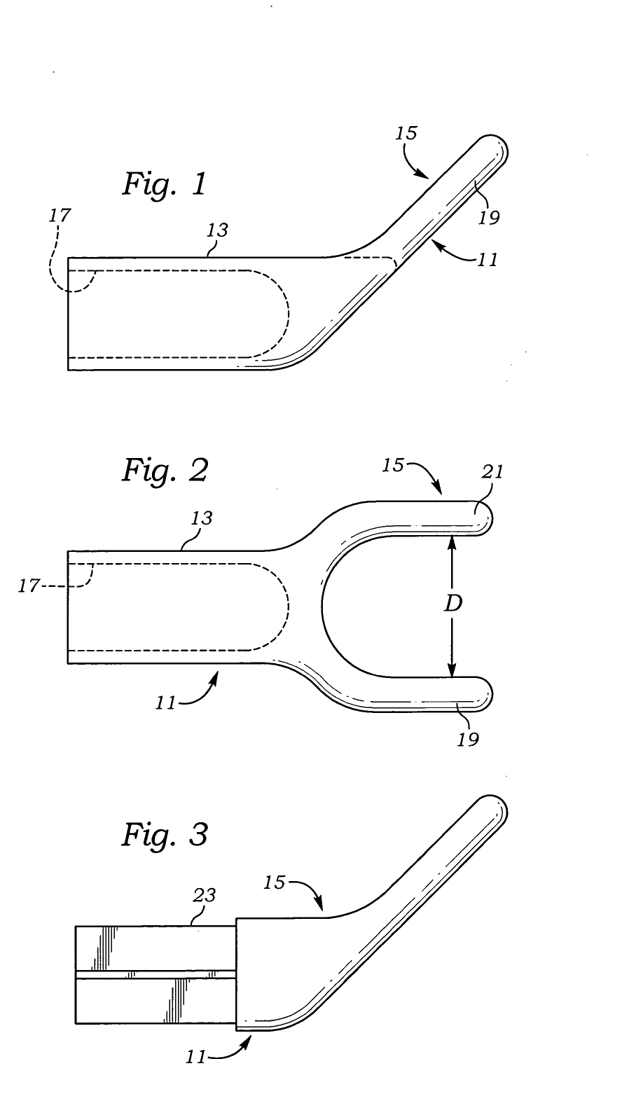

The description and operation of the invention will be best initiated with reference to FIG. 1 which illustrates a side sectional view of a fork bracket 11 having a rearwardly located tube portion 13 and a forward forked portion 15 which is angled at approximately 45° with respect to the axis of the tube portion 13. The tube portion 13 has an internal cavity 17. The cylindrical outer shape of the tube portion 13 and the inner cylindrical internal cavity 17 facilitates support of the fork bracket from a tube (not shown) by either fitting the internal cavity 17 onto the exterior of a tube or by fitting the cylindrical outer shape of the tube portion 13 within an internal diameter of a tube. The internal cavity 17 is illustrated as having a radiused terminus, but a flat terminus would work equally well.

Referring to FIG. 2, a top view of the fork bracket 11 gives a more complete visual illustration and details the existence of a first fork 19 separated from a second fork 21. The forks 19 and 21 are separated by a distance D. The transition from the fork 19 to 21 is through a curved radius matching the distance D of preferably about 2.00 inches. The depth of the spacing between the forks 19 and 21 may preferably be about 2.25 inches from the vertical perspective looking down. Using sine and cosine relationships, the distance from the tip ends of the forks 19 and 21 to the radiused transition may be about 3.2 inches. Again, the distances and transitions need not be radiused, and the structures are shown as radiused for aesthetic purposes. The materials employed and method of manufacture may predominated in specifying details.

For example, rather than having a tubular rear portion 13 which can fit either inside of a smaller pipe or inside of a larger pipe, a different structure can be provided. Referring to FIG. 3, a fork bracket 11 has fin shaped rearwardly located portion 23 for fitting inside a pipe. The bilateral symmetry of the fin shape makes the fork bracket 11 more amenable to the injection molding method of manufacture. Similarly, the fork bracket 11 can lead to a flat plate, or any other structure which permits it to be supported in substantially the same angled orientation as FIGS. 1-3, generally with the rear portion orthogonal to pull of gravity to enable the forward forked portion to support and urge the supported member toward the rearwardly located member, either rearwardly located tube portion 13 or fin shaped rearwardly located portion 23.

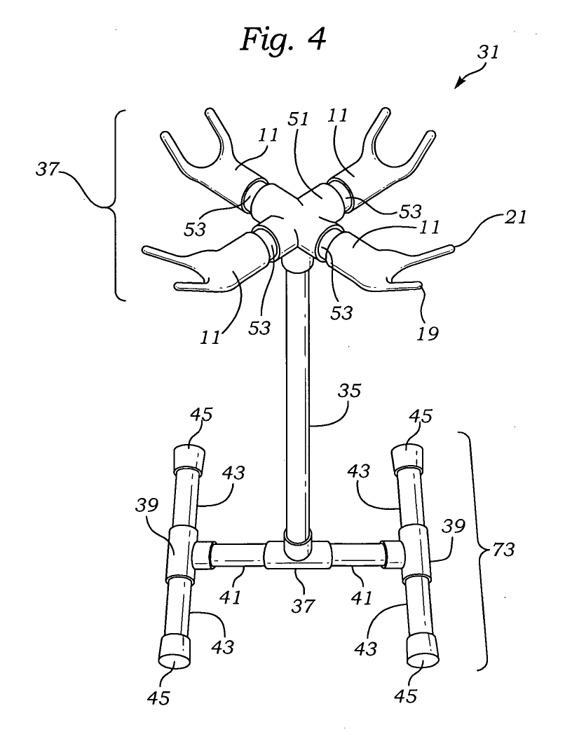

After having established the fork bracket 11, further elemental structure will be illustrated as a rack with four such fork brackets 11 in a simple, lightweight configuration for holding four skateboards. The use of polymeric piping, such as polyvinyl chloride (PVC) piping can provide a very sturdy, lightweight structure. Referring to FIG. 4, a one level stand 31 is illustrated. The stand 31 has an “H” shaped base portion 33, a vertical support 35 supporting a cross shaped four member fork bracket assembly 37.

It should be understood that the “H” shaped base portion 33 could be replaced by any member or structure which is enabled to sturdily support a vertical support 35. In this case, and for simplicity, the “H” shaped base portion 33 is formed using tube or pipe fittings, including a center “T” fitting 37, and a pair of side “T” fittings 39. A number of pipe sections are used to interfit with the “T” fittings 37 and 39 including short lengths of connector pipe 41 between the “T” fittings 37 and 39, and longer protruding lengths of connector pipe 43 which are connected to the “T” fittings 39. Depending upon the diameter sizes chosen, the connector pipes 41 and 43 can be sized to extend completely through their respective “T” fittings 37 and 39, or can be sized to fit separately, one piece in each respective end of their “T” fittings 37 and 39. A set of four soft polymeric end caps 45 are shown attached to the protruding terminal ends of the connector pipes 43 both for balance and to provide a clearance above the floor for any portions of the “T” fittings 37 and 39 which might extend below the cylindrical extent of the connector pipes 41 and 43.

In terms of sizes and dimensions, the use of PVC piping has worked well with an overall length of the of the connector pipes 43 being about sixteen inches in length, and the overall width of the “H” shaped base portion 33 extending just beyond the overall length of the connector pipe 41, being about eighteen inches. The “T” fittings 37 and 39 have an overall dimension of about four and a half inches in the linear pass through portion, and about three and one third inches in the perpendicular connector portion. The diameter of the connector pipes 41 and 43 is approximately one and one quarter inches, such as a standard one and a quarter ASTM D1785 schedule 40 pipe. With this size of connector pipe 41 and 43, the “T” fittings 37 and 39 would have an outside diameter of about two inches. The outside diameter of the soft polymeric end caps 45 should be sufficiently large to insure that the “T” fittings 37 and 39 will be lifted off of any surface onto which the one level stand 31 is placed, and under loading conditions to account for any deflection of the connector pipes 41 and 43. The vertical support 35 is preferably made of a pipe material consistent with the connector pipes 41 and 43. The overall length of the vertical support 35 is preferably twenty eight and three quarter inches.

The a cross shaped four radial member fork bracket assembly 37 may include a five way pipe connector 51 to which short lengths of optional fork bracket connector pipe 53 are attached to the cross shaped four member radial upper openings, with an opening underneath the five way pipe connector 51 for fitting onto the top of the vertical support 35. Each of the fork bracket connector pipes 53 connect to an individual fork bracket 11. As before, the connecting pipe 53 can connect to the inside or outside of the individual fork brackets 11. In FIG. 4, the individual fork brackets 11 are engaged by the short lengths of fork bracket connector pipe 53 at the inside of the individual fork brackets 11.

Also seen in FIG. 4 is that the a cross shaped four member fork bracket assembly 37 is oriented so that each of the individual fork brackets 11 overlie the end terminus of the longer protruding lengths of connector pipe 43 in order to give maximum stability and support when a skateboard is suspended from any one of the individual fork brackets 11. In using the one level stand 31, the first skateboard (not shown in FIG. 4) should be loaded onto a first fork bracket 11, with a second skateboard then loaded onto the opposite fork bracket 11. The one level stand 31 can also support other suspended items such as backpacks and the like.

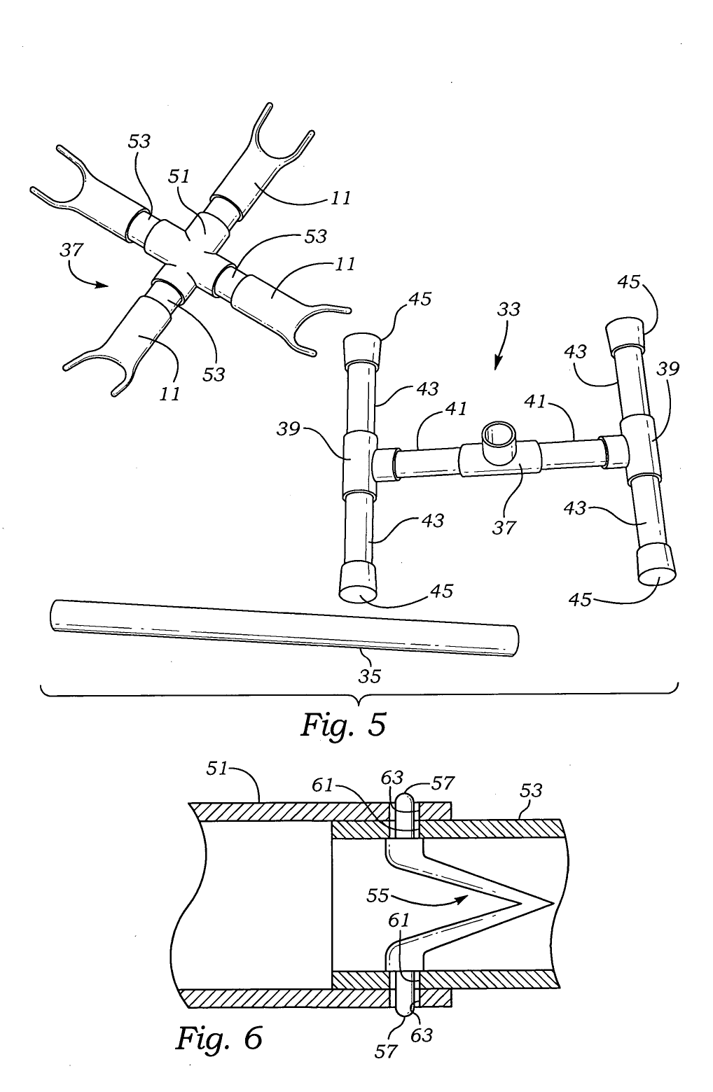

In terms of pre-assembly, FIG. 5 illustrates a three-piece breakdown in which the “H” shaped base portion 33 and the cross shaped four member fork bracket assembly 37 may be completely pre-assembled and provided along with the vertical support 35. The members shown sill fit easily within a box which is just slightly larger than the maximum dimension of the “H” shaped base portion 33, for easy transport and storage. The pre-assembly seen in FIG. 5 will require only the interfitting of the vertical support 35 between “H” shaped base portion 33 and cross shaped four member fork bracket assembly 37 for setup. In this configuration, the use of glue or cement between the connector pipe 41, 43, & 53 and the members they attach to would be acceptable. This configuration also lends itself to the ability to be completely finished, such as painting or metalization for a more pleasing aesthetic look. It also enables other sub sets of the aforementioned individual components to be manufactured as one-piece units. For example, the “H” shaped base portion 33 and the a cross shaped four member fork bracket assembly 37 might be manufactured as a single unit, using easily injection moldable inverted “U” shaped channel to provide enhanced mechanical support.

Where further breakdown is desired and where the aforementioned components are used, quick disconnects can be provided. Referring to FIG. 6, a side view of a connector intersection between a pipe section, in this case connector pipe 53, and a connector, in this case five way pipe connector 51, is seen, but utilizing a double pin thumb release 55 to lock the members together and to enable a more complete breakdown of components. The double pin thumb release 55 utilizes a pair of oppositely located cylindrical members 57 connected to a spring structure 59. The spring structure 59 serves to keep the pair of oppositely located cylindrical members 57 in alignment and urged away from each other. The double pin thumb release 55 typically resides inside the smaller tube with the spring structure 59 extending away from the open end of the smaller tube structure.

In this case, fork bracket connector pipe 53 hold the double pin thumb release 55 with the spring structure 59 extending into the fork bracket connector pipe 53. When initially inserted into the fork bracket connector pipe 53, the oppositely located cylindrical members 57 are brought together and the double pin thumb release 55 is inserted into the oppositely located cylindrical members 57, the spring structure 59 end first. Initial engagement through apertures 61 in the fork bracket connector pipe 53 will be sufficient to hold the double pin thumb release 55 in place. The oppositely located cylindrical members 57 are pressed inward from the outside of fork bracket connector pipe 53 to clear the five way pipe connector 51 to enter the five way pipe connector 51. Once inside the five way pipe connector 51 the oppositely located cylindrical members 57 will springingly urge through a set of apertures 63 in the wall of the five way pipe connector 51 and releasably lock the fork bracket connector pipe 53 to the five way pipe connector 51. The use of the double pin thumb release 55 can occur at each pipe 35, 41, 43, 53 with respect to their fittings, including fork bracket 11 rearwardly located tube portion 13, center “T” fitting 37, pair of side “T” fittings 39, and five way pipe connector 51. However, the small size of the one level stand 31, and especially the cross shaped four member fork bracket assembly 37 may encourage a more permanent assembly for this small sized embodiment. However, larger embodiments utilizing larger diameter pipe would benefit from the ability to perform a more complete breakdown and disassembly.

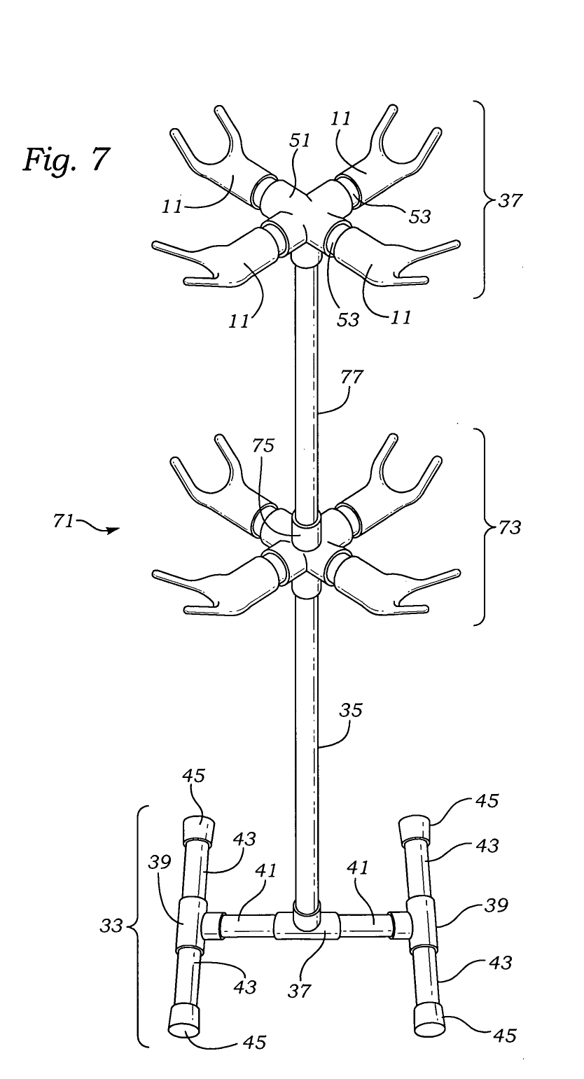

Referring to FIG. 7, a two level stand 71 is seen which includes at its uppermost level, the cross shaped four member fork bracket assembly 37 seen in FIGS. 4 and 5. However, a middle cross shaped four member fork bracket assembly 73 includes a six way pipe connector 75, and is supported by a second vertical support 77.

Note that the middle cross shaped four member fork bracket assembly 73 is placed at a 45° angle with respect to the upper cross shaped four member fork bracket assembly 37 to enable skateboards to be staggered so that the lower ends of the skateboards are angled toward the vertical supports 35 and 77 such that the lower ends of the upper rank of skateboards are tucked to the inside of and between adjacent upper ends of the skateboards of the lower rank of skateboards. In this fashion, subsequent vertically displaced fork bracket assemblies can create a series of “tucked” displays ranks in which the upper part of each skateboard prominently extends outward, and gives a lower tapering view as it visually disappears between adjacent upper skateboards of the next lower rank.

Such a display in a commercial environment may be made of steel and may extend to the ceiling. In such a commercial embodiment, the stand may be supported at the upper end by the room in which it is placed. Further, such a rack vertically extending to the ceiling may preferably rotate. Where such a rack does not extend to the ceiling, the base may include a much heavier structure such as a solid metal or weighted base.

A commercial stand may include a greater number of forked brackets on each level, and may be supported by a circular structure such as a ring or circle. The expanded diameter of the stand will dictate an expanded diameter base. In a commercial application where persons are expected to walk around the stand, the base is more likely to be heavier and abbreviated in diameter to facilitate clearance for walking around the stand.

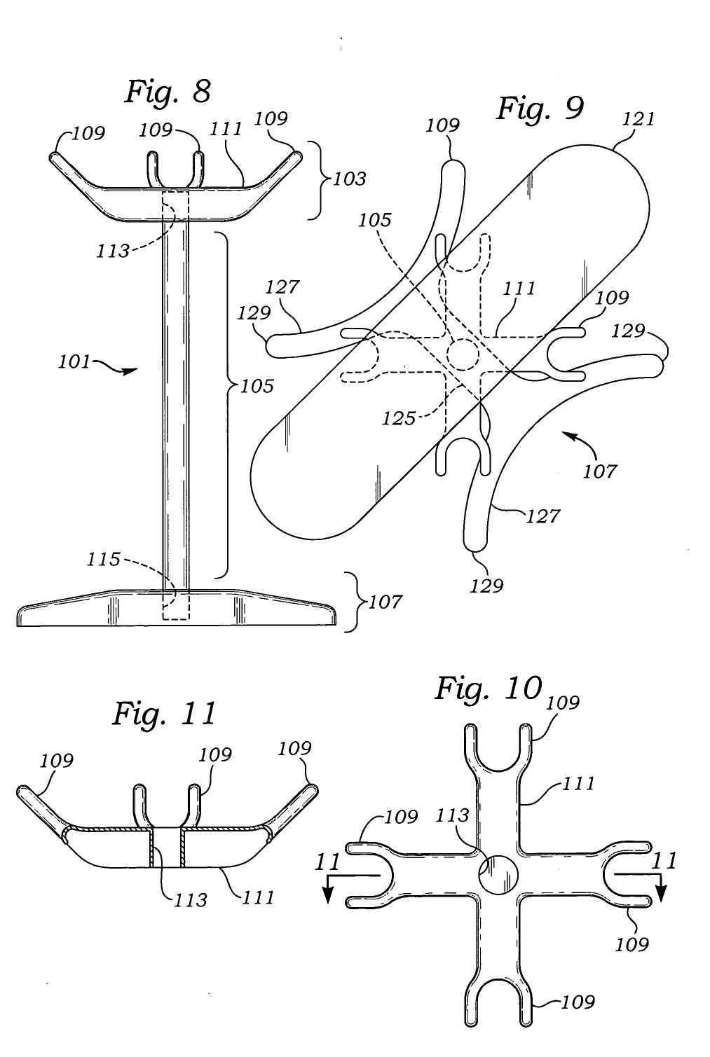

Referring to FIG. 8, a further embodiment is seen as a one level stowable stand 101. The one level stowable stand 101 is meant for quick set up and stowable break down. A one piece upper rack 103 fits easily over a cylindrical pole 105 after the cylindrical pole is slip fit into a base 107. Cylindrical pole 105 may preferably be made of metal or plastic and may have a length of from about twenty four to about thirty four inches. This configuration enables the user to disassemble the one level stowable stand 101 for small area stowage.

The one piece upper rack 103 has four extending fork brackets 109 which are blended smoothly from a tubular “cross” shaped inner support 111. The extending fork brackets 109 have no seams or other interruptions and present a smooth, artful appearance. The tubular “cross” shaped inner support 111 could be replaced or augmented by a rounded structure from which the extending fork brackets 109 extend. A rounded hub could have more or less than four of the fork brackets 109 which could also blend smoothly from any structure. The center of the tubular “cross” shaped inner support 111 has a bore structure, or bore 113 which accommodates enough of the upper end of the pole 105 to give stability. Similarly, the base 107 has a bore 115 for accommodating enough of the upper end of the pole 105 to give stability. It may be preferable to provide a smooth connection so that the one piece upper rack 103 can rotate with respect to the cylindrical pole 105, which may also be able to rotate with respect to the base 107.

Referring to FIG. 9 a view looking down onto the one level stowable stand 101 illustrates a skateboard 121 which may be laid across the one piece upper rack 103, in addition to using one of the four extending fork brackets 109 to engage the axle of the skateboard 121 just inside the wheels of skateboard 121 (not shown).

As can be seen from the view of FIG. 9, base 107 includes a main horizontal member 125 which has two ends connecting a pair of end horizontal members 127. The boundaries between the main horizontal member 125 and pair of end horizontal members 127 appear smooth and continuous while providing terminal ends 129 of the pair of end horizontal members 127 as four widely spaced stabilization points.

Referring to FIG. 10, a bottom view of the one piece upper rack 103 illustrates the bore 113. Referring to FIG. 11, a view taken along line 11-11 of FIG. 10 illustrates a possible open inverted “U” shaped nature of the tubular “cross” shaped inner support 111. As can be seen in FIGS. 8-11, the width of the internal width of the fork portion of the four extending fork brackets 109 is about the same as the width of the tubular “cross” shaped inner supports 111.

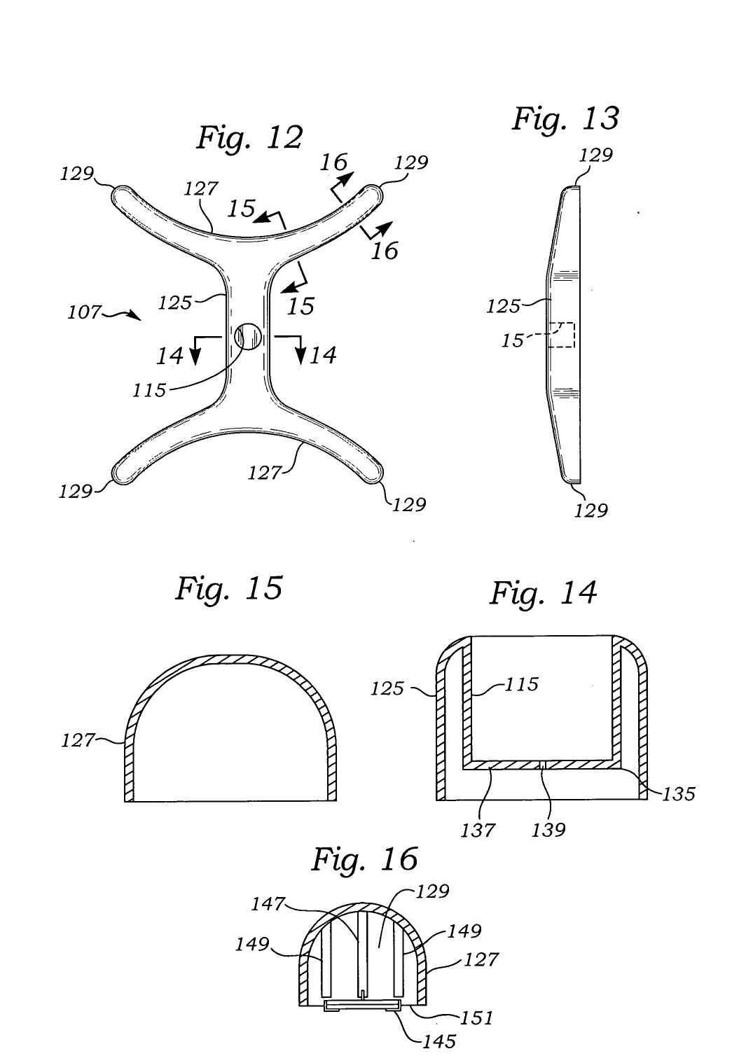

Referring to FIG. 12, a top view looking down onto the base 107 better illustrates the overall shape. On the base 107 are a series of section indicators illustrating sectional views to follow. Referring to FIG. 13, a side view in a corresponding orientation as was seen for FIG. 12 illustrates the side profile.

Referring to FIG. 14, a view taken along line 14-14 of FIG. 12 illustrates internal details for the support of pole 105. An internal bore 115 is part of a cup structure 135 also having a bottom member 137. Bottom member has an air vent and drainage aperture 139 to drain away any moisture which becomes trapped between the pole 105 and the internal bore 115 and bottom member 137, as well as to allow displacement air to enter and escape air upon insertion or withdrawal of the pole 105.

Referring to FIG. 15, a sectional view taken along line 15-15 of FIG. 12 illustrates a shape of the pair of end horizontal members 127 closer to the main horizontal member 125.

Referring to FIG. 16 is a sectional view taken along line 16-16 of FIG. 12 illustrates one potential configuration for supporting an optional non-skid foot pad 145. A series of vertical extensions including a main extension 147 and a pair of side extensions 129. The main extension 147 extends from the top of the end horizontal member 127 while and a pair of side extensions 129 extend from an area between the tops and sides of the end horizontal members 127. As can be seen, the optional non-skid foot pad 145 extends below a bottom edge 151 of the end horizontal members 127.

While the present invention has been described in terms of a skateboard support, & more particularly to a support which includes a motif which can be expanded vertically and in terms of its diameter, the mechanisms and support techniques disclosed can be applied to other devices.

Although the invention has been derived with reference to particular illustrative embodiments thereof, many changes and modifications of the invention may become apparent to those skilled in the art without departing from the spirit and scope of the invention. Therefore, included within the patent warranted hereon are all such changes and modifications as may reasonably and properly be included within the scope of this contribution to the art.

What is claimed:

1. A skateboard support comprising:
at least one pair of oppositely disposed forked brackets, each having a forward forked portion in a first plane having a first angle with respect to a rearward portion, each said forked portion having at least a pair of mirror image spaced apart forks for engaging an axle set on a skateboard;
a fork bracket support assembly attached to each rearward portions, for supporting said at least one forked bracket;
a vertical support supporting said fork bracket support assembly; and
a base portion supporting said vertical support.

2. The skateboard support as recited in claim 1 wherein said forked bracket rearward portion is cylindrical and includes an annular bore extending at least partially into said forked bracket rearward portion.

3. The skateboard support as recited in claim 1 wherein said fork bracket support assembly further comprises:
a pipe connector supported by said vertical support;
at least one pipe extending from said pipe connector and engaging said at least one forked bracket.

4. The skateboard support as recited in claim 1 wherein said base portion supporting said vertical support further comprises:
a central pipe “T” fitting having an orthogonal opening supporting said vertical support;
a first pair of short lengths of connector pipe extending collinearly away from said central pipe “T” fitting and perpendicular with respect to said vertical support;
a first lateral pipe “T” fitting having a first connection to one of said first pair of short lengths of connector pipe extending collinearly away from said central pipe “T” fitting;
a second pair of short lengths of connector pipe extending collinearly away from said first lateral pipe “T” fitting;
a second lateral pipe connector having a first connection to the other one of said first pair of short lengths of connector pipe extending collinearly away from said central pipe “T” fitting;
a third pair of short lengths of connector pipe extending collinearly away from said second lateral pipe “T” fitting.

5. The skateboard support as recited in claim 1 wherein said forked bracket rearward portion is fin shaped.

6. The skateboard support as recited in claim 1 wherein said first angle is about 45°.

7. A skateboard support comprising:
at least a first pair of oppositely disposed forked brackets, each having a forward forked portion in a first plane having a first angle with respect to a rearward portion, each said forked portion having at least a pair of mirror image spaced apart forks for engaging an axle set on a skateboard, said rearward portions continuous with each other to form a tubular shaped inner support, said inner support having a first bore;
a vertical support having a first end for fitting within said first bore for supporting said at least one pair of oppositely disposed forked brackets, and a second end; and
a base having a main horizontal member having a first end attached centrally to a first end horizontal member and a second end attached centrally to a second end horizontal member, said main horizontal member having a second bore for lending support to said second end of said vertical support.

8. The skateboard support as recited in claim 7 wherein said at least a first pair of oppositely disposed forked brackets is a first pair of oppositely disposed forked brackets and further comprising:
at least a second pair of oppositely disposed forked brackets, each having a forward forked portion in a first plane having a first angle with respect to a rearward portion, each said forked portion having at least a pair of mirror image spaced apart forks for engaging an axle set on a skateboard, said rearward portions of said at least a second pair of oppositely disposed forked brackets angularly spaced apart from said first pair of oppositely disposed forked brackets.

9. The skateboard support as recited in claim 8 wherein said at least a second pair of oppositely disposed forked brackets is a second pair of oppositely disposed forked brackets and wherein rearward portions of said first pair of oppositely disposed forked brackets are orthogonal to said rearward portions of said second pair of oppositely disposed forked brackets to form a tubular cross shaped inner support.

10. The skateboard support as recited in claim 7 wherein said first and second end horizontal members are curved outwardly.
